(19) United States
(12) Patent Application Publication
(10) Pub. No.: US 2010/0243963 A1
(43) Pub. Date: Sep. 30, 2010

(54) Doping and milling of granular silicon

(75) Inventor: Raanan Zehavi, Sunnyvale, CA (US)

Correspondence Address: LAW OFFICES OF CHARLES GUENZER, P O BOX 60729, PALO ALTO, CA, 94306, US

(73) Assignee: INTEGRATED PHOTOVOLTAICS, INCORPORATED, Sunnyvale, CA (US)

(21) Appl. No.: 12/749,160

(22) Filed: Mar. 29, 2010

Related U.S. Application Data
(60) Provisional application No. 61/165,218, filed on Mar. 31, 2009.

(51) Int. Cl. H01B 1/04; C01B 33/02; B05D 1/02; B02C 13/02; B02C 23/02

(52) U.S. Cl. 252/500; 423/348; 427/212; 241/195; 241/185.5

(57) ABSTRACT

Doped silicon particles, including powder suitable for plasma spraying semiconductor devices, is formed by liquid doping applied to larger particles, which are then milled to a smaller size. Doped or undoped silicon may be milled by a roller mill including silicon rollers and advantageously having feed and collection systems formed of silicon and operated in a nitrogen ambient. A two-stage system includes sieving the rolled product for further size reduction in a jet mill.

### RELATED APPLICATION

This application claims benefit of provisional application 61/165,218, filed Mar. 31, 2009.

### FIELD OF THE INVENTION

The invention relates generally to producing silicon grains forming a powder useful for plasma spraying semiconducting devices such as solar cells. In particular, the invention relates to both the doping and milling of such silicon powder.

### BACKGROUND ART

Integrated circuits based upon semiconducting silicon have conventionally been formed in monocrystalline silicon wafers cut from ingots grown by the Czochralski method, which includes pulling the ingot from a melt of pure silicon. Solar cells can also be made in such wafers, but the conventional monocrystalline silicon wafers are generally considered to be too expensive for solar cells to be effectively and widely deployed as an economical replacement for commercial power. As a result, much recent effort has been directed to developing economical techniques for depositing a semiconductor silicon layer on another substrate.

One such technique involves plasma spraying thin layers of silicon onto foreign substrates, as described by Zehavi et al. in U.S. patent application Ser. No. 12/074,651, filed 5 Mar. 2008 and now published as U.S. patent application publication 2008/0220558. Zehavi discloses an improved design of the gun nozzle in U.S. patent application Ser. No. 12/720,123, filed 9 Mar. 2010. This technique includes injecting silicon powder into the flame of a plasma spray gun and directing the flame and entrained silicon toward the substrate. The silicon powder is melted and perhaps vaporizes in the flame but quickly solidifies when it strikes the substrate and forms a silicon layer it.

However, to form a photovoltaic solar cell or any type of significant semiconducting device, the device must includes layers of silicon of different conductivity types.

Further, the size of the powder used in plasma spraying must be controlled within a fairly narrow range of small dimension to facilitate processing. It have been found desirable to mill or otherwise reduce the size of silicon particles otherwise available on the market. However, the milling must maintain the purity of the silicon. Zehavi et al. have disclosed a jet mill for reducing the size of the silicon particles in US patent application Ser. No. 11/782,201, filed 24 Jul. 2007, now published as U.S. patent application publication 2008/0054116, and incorporated herein by reference. In order to maintain the purity of the milled silicon, the jet mill has walls composed of silicon so that the milling process does not incorporate non-silicon wall material into the milled silicon.

However, further development work in our laboratory has suggested the typical commercially available silicon particles, such as BB pellets, used as feedstock to the mill rapidly degrade the silicon parts of the milling chamber. Although the parts can be easily replaced with new silicon parts, silicon parts are generally expensive. If the final use of the milled powder is forming solar cells, it is important that all stages of the manufacturing process be economical to allow solar cells to compete with other more conventional forms of electrical power.

### SUMMARY OF THE INVENTION

According to one aspect of the invention, silicon particles are doped to n-type or p-type semiconductivity by exposure to a liquid doping agent and then ground to smaller size. The smaller-sized particles produced by mechanical milling may be further reduced in size by jet milling to a powder of size suitable for plasma spraying of silicon, for example, of diameter of 1 to 5 microns.

The doping concentration in the final silicon can be controlled by milling undoped silicon particles to the same size as the doped ground silicon particles and mixing the two batches of particles in predetermined proportion to achieve the desired doping concentration.

According to another aspect of the invention, silicon particles are crushed to smaller size by a roller mill including two counter-rotating silicon rollers.

The roller milling system may include a feed system which reciprocates along the lengths of the rollers in delivering silicon particles to the rollers. The feed system may include a linear funnel having a linear, generally rectangular outlet positioned away from the gap between the rollers. The funnel, a vibrating feeding trough for the funnel, and a collector pan positioned beneath the inter-roller gap are advantageously composed of silicon.

The roller milling system and its feed system are advantageously disposed within an environmental chamber back filled with an inert gas such as nitrogen. If the crushed particles are then jet milled to a yet smaller size, the jet mill is advantageously placed in the same environmental chamber.

### BRIEF DESCRIPTION OF THE DRAWINGS

FIG. 1 is a schematic cross-sectional view of a spraying apparatus for liquid doping of silicon particles according to one aspect of the invention. FIG. 2 is an orthographic view of one embodiment of a roller mill of another aspect of the invention.

FIG. 3 is an exploded orthographic view of the roller mill of FIG. 2.

FIG. 4 is a yet further exploded view of FIG. 3.

FIG. 5 is a cross-sectional view of the chamfered end of one of the rollers of FIG. 1.

FIG. 6 is a schematic cross-sectional view of a feeding system for the roller mill of FIG. 2.

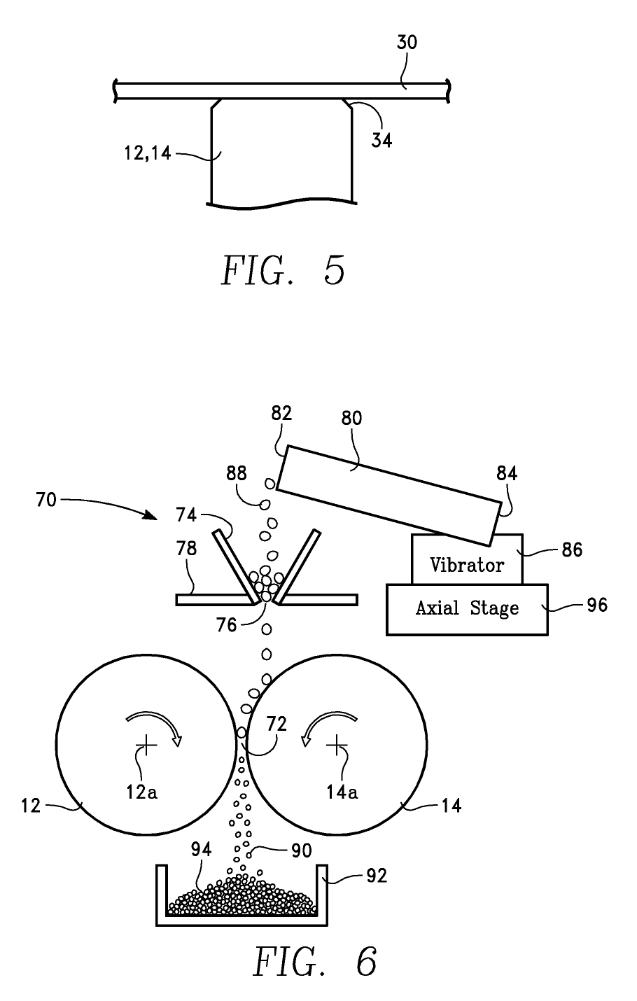

FIG. 7 is a schematic representation of a environmental chamber in which the roller mill of FIG. 2 is disposed in an inert ambient.

### DETAILED DESCRIPTION OF THE PREFERRED EMBODIMENTS

Different aspects of the invention include mechanical grinding or crushing of silicon pieces to small particles of high purity and of controlled size and the semiconductor doping of such silicon particles. The mechanical grinding may be followed by an optional sieving and subsequent jet milling of the particles into yet smaller silicon powder. However, the silicon feedstock must be highly pure and the purity should be maintained during the grinding process.

The semiconductor industry has promoted the development of economical production of electronic grade silicon (EGS) of very high purity. In the usual Siemens process, gaseous precursors of hydrogen and trichlorosilane are injected into a reactor containing a hot seed rod of silicon. The precursors in a chemical vapor deposition (CVD) process deposit onto the seed rod as growing layers of polysilicon silicon to form a rod or ingot of EGS, also called virgin polysilicon. The growth conditions favor the formation of high stress in the ingots. At the end of growth, the ingots are cooled and hit by a sharp instrument on the order of a hammer so that the ingot shatters into irregular chips or shards of silicon of size on the order of 2 mm to 20 mm typically having irregularly arranged sharp corners. The silicon chips are used to as feedstock to fill the crucible, which is then heated to melt the silicon from which monocrystalline silicon ingots are pulled in the Czochralski process. A related fluidized bed process uses approximately the same chemistry to produce a continuous output of generally spherical pellets or BBs of diameter on the order of 1 to 3 mm.

Either the chips or the pellets should be milled to the smaller sizes required for plasma spraying or otherwise applying a layer of silicon powder to a substrate. However, it is advantageous to dope the silicon feedstock before the feedstock is reduced in size to the powder. Solar cells and other semiconductor devices require doping levels in the vicinity of 10¹⁴ to 10¹⁹ cm⁻³, which compares to a silicon concentration of 10²² cm⁻³ so that only a very small fraction of dopant incorporation is desired and that needs to be fairly closely controlled.

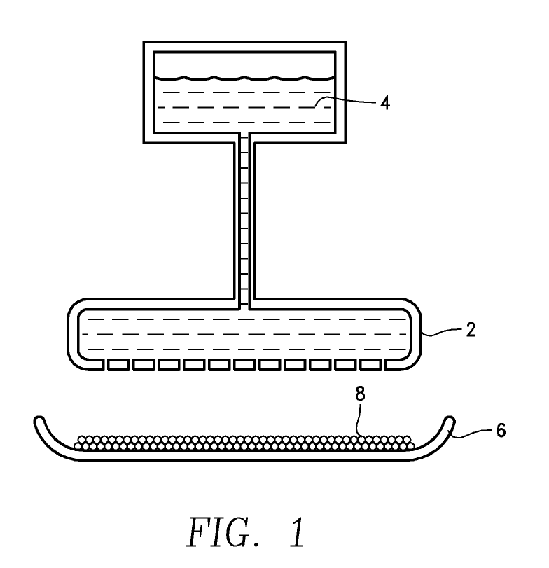

In one aspect of the invention, the silicon shards or pellets are doped by spraying them with a liquid doping agent. An exemplary embodiment of a spraying system schematically illustrated in the cross-sectional view of FIG. 1 includes a showerhead 2 supplied with a liquid doping agent from a tank 4 and positioned over a container 6 having an open top and containing a thin layer of silicon particles 8 to be doped. The liquid doping agent exits the apertures of the showerhead 2 as jets and preferably as a fine mist evenly applied to the silicon particles 8. The spray misting effectively coats the silicon particles with a thin film of the liquid dopant with relatively little pooling of the liquid under the particles. Unillustrated metering valves disposed between the tank 4 and the showerhead 2 and an associated controller determines the total amount of liquid doping agent applied to a known quantity of silicon particles 8.

An example of a p-type liquid doping agent is boric acid. Boric acid is itself a solid at room temperature, typically in powder form, having a formula B(OH)₃, but is readily soluble in water or some alcohols. This is the ortho form of boric acid. The tetra form H₂B₄O₇ is also called boric acid. The ortho boric acid is dissolved in a solvent to a known concentration, e.g. 0.1365 mol/l in deionized water. A known amount of the solvent is then sprayed onto a known amount of the silicon chips or pellets in an amount that does not significantly drain from the silicon particles. The solvent is then evaporated. Heating of the boric acid coating tends to convert it to boron oxide (B₂O₃), which has a sublimation temperature of 3000° C. However, it reacts with silicon according to

2B₂O₃+3Si→3SiO₂+4B.

The boron readily diffuses in silicon at higher temperatures, especially those required for recrystallization, and thus can assume a doping interstitial position in the silicon lattice. Although the reaction and dopant diffusion may be performed by an anneal of the coated silicon particles, when the final powder is used for plasma spraying, the plasma spraying itself drives the reaction and the diffusion can easily occur in the liquid phase Also, the zone melt recrystallization (ZMR) contemplated for producing solar cells will also produce the required high temperatures for reaction and diffusion. The boron incorporation rate depends on the processing and may be in the vicinity of 10 to 20%. Other boron sources include boron tribromide (BBr₃) and trimethylborate ((CH₃O)₃B but other sources and other p-type dopants in liquid form are possible.

An example of a corresponding n-type liquid doping agent is phosphorus oxychloride (POCl₃), which has a melting point of 2° C. and a boiling point of 105° C. and may be used by itself or in solution with water or alcohol. The POCl₃ is converted to P, which diffuses into the silicon. Other liquid sources of phosphorous and other n-type dopants in liquid form are possible.

The silicon particles may be immersed in liquid dopant or the solution including the dissolved doping agent, but the amount of dopant adhering to the particles is more difficult to control during immersion.

Very low doping concentrations can be better controlled by doping only a known fraction of the silicon particles. The preferred method dopes some silicon particles in one batch but leave other silicon particles undoped in another batch. Both batches are respectively milled or otherwise pulverized to produce similarly sized but segregated powders of much smaller size. The doped and undoped powders are then mixed in known proportions and homogenized as much as possible. The average doping concentration of mixed powder is thereby reduced according to the fractions of doped and undoped powders.

The liquid doping procedure is difficult to control for a precise predetermined doping level. Controlled doping can be achieved by preparing a mixed or unmixed batch of doped powder as a doping run batch, plasma spraying the doping run batch, and measuring the resistivity of the resulting sprayed silicon film, which is easily converted to doping concentration. The doping concentration or resistivity of the doping run sample is then compared to the desired concentration or resistivity, and a production run batch of silicon powder is prepared from fractions of doped powder of the doping run batch and undoped powder in amounts determined by the comparison.

The shards or pellets can be milled in at least two different procedures. In the first, relatively small silicon particles, such as BB pellets, are fed into a jet mill in which the particles are entrained in a vortex and strike each other or the walls of the milling chamber to progressively reduce the size of the particles as was described above for application publication 2008/0054106. However, most commonly available silicon particle feedstock has larger size than desired and prematurely degrades the expensive silicon parts of the milling chamber.

It is desirable to first reduce the size of silicon feedstock in a roller mill. The feedstock may be either the millimeter sized CVD pellets or the larger and more irregularly shaped shards from fractured boules of virgin polysilicon (electronic grade silicon).

The roller milling process of one embodiment of the invention crushes the particles between two closely spaced counter-rotating rollers having surfaces composed of high-purity silicon. In one embodiment illustrated in the orthographic view of FIG. 2, a roller mill 10 includes two rollers 12, 14, each right cylindrically shaped about respective roller axes and composed of high-purity silicon, such as virgin polysilicon (electronic grade silicon) as described by Boyle et al. in U.S. Pat. No. 6,617,225 or float zoned silicon. Although silicon surfaces on a roller body of another material suffice, it has been found that solid elemental silicon can be easily machined into rollers which withstand the rigors of roller milling. Elemental silicon has a silicon content of at least 95 at % and has a majority of the silicon atoms bonded to one another through tetrahedral covalent bonds. The right cylindrical surfaces may be smooth or one or both of the rollers 12, 14 may have patterned surfaces to facilitate grinding by more effectively gripping the particles. The rollers should be machined to very tight tolerances to allow a very small minimum gap between them of the order of 25 microns. To achieve such a gap and allow the rollers to rotate without binding, the circularity should be 1/1000 inch (25 microns) or less, that is, outer diameters that differ ±0.0005 inch from the average. The circularity is preferably substantially less than the desired size of ground powder since the circularity limits how closely the rollers can be separated. Shafts are fixed on the rollers 12, 14 and portions extending from the opposed roller ends are mounted on a metal frame 16 through bearings supported in respective bearing housings or carriers 18, 20 (only two of the four being illustrated). The carriers 18, 20 are horizontally movable over short distances within windows 22 in the frame 16 to adjust the gap between the rollers 12, 14 and their parallelism but the carriers 18, 20 can be fixed at their desired horizontal positions. The rollers 12, 14 are mounted within a central opening of the frame 16 with a generally horizontal orientation with the axes of the rollers 12, 14 generally parallel in a same plane, which is either horizontal or a few degrees away from horizontal. Two motors 24 drive respective reducing gears 26, which are coupled through respective flexible shaft couplings 28 to the shafts of the respective rollers 12, 14 and rotate them in opposite directions, that is, counter-rotating rollers, at approximately the same rotation rate of about 2 to 5 rpm for rollers of diameter of about 4 to 6 inches (10 to 15 cm). However, it has been found that slightly different rotation rates between the rollers 12, 14 operates better and more smoothly and avoids the pellets binding the rollers 12, 14. Clutches or torque limiters may be interposed between the motors 22, 24 and the rollers 12, 14. More simply, the current to the motors 24 may be controllably limited. In an improved design, motor torque may be specified and adjusted periodically.

The flexible shaft couplings 28 are intended to allow some angular misalignment or nutation between the shafts of the rollers 12, 14 and the associated motors 24 as the hard silicon particles forced between the rollers 12, 14 exerts great force on the rollers 12, 14 and causes them to separate. The flexible shaft couplings 28 may be a two-stage bellows coupling with a rigid ring attached between them. The two sets of bellows provide rigid rotational torque but allow the rotational axes to bend. Thereby, the motor and roller shafts maybe slightly inclined or radially displaced from each other. Such flexible shaft couples are available from Nuland Manufacturing Co. of Marlborough Mass.

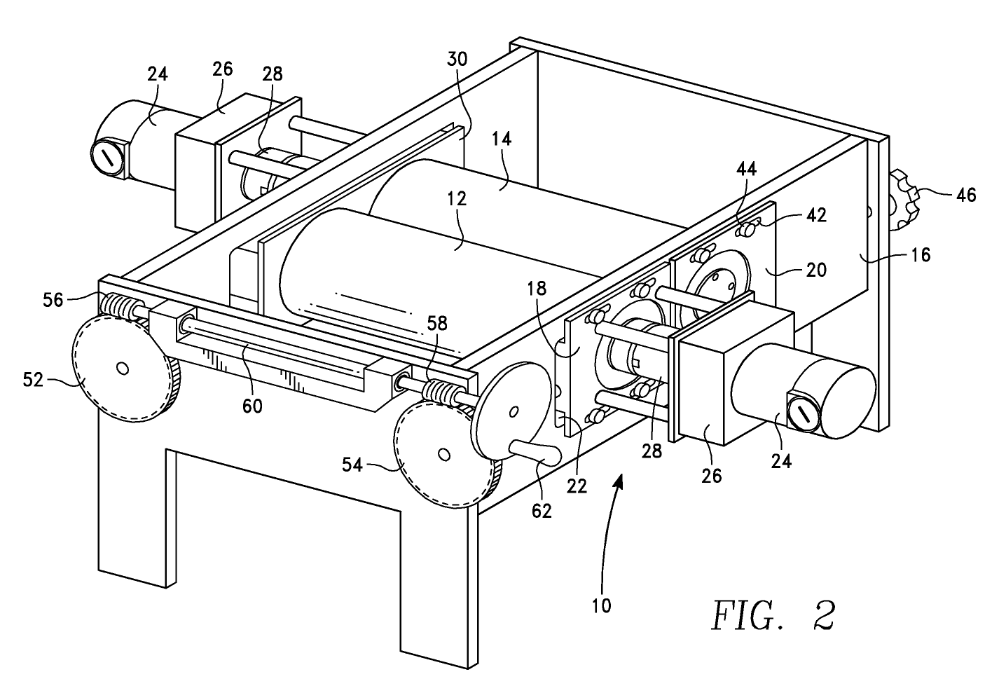

As illustrated in more detail in the enlarged orthographic view of FIG. 3, end plates or shields 30 are mounted to the inside of the frame 16 through compression springs 32 connected between the carriers 18, 20 and the shields 30 which bias the shields 30 against the axial ends of the two rollers 12, 14. However, the shields 30, which may be generally flat, include apertures for the shafts of the rollers 12, 14. The springs 32 cause the shields 30 to abut the ends of the rollers 12, 14, to prevent unground and partially ground particles from falling off the ends of the rollers 12, 14 and thereby shield the bearings from the grinding dust. The shields 30 may also be composed of high-purity silicon, such as virgin polysilicon, so that any grinding between the rollers 12, 14 and the shields 30 produces only high-purity silicon particles and thus protects the rollers 12, 14 from metallic contamination. However, the secondary grinding should be minimized and there may be a more complexly shaped interface between the rollers 12, 14 and the shields 30.

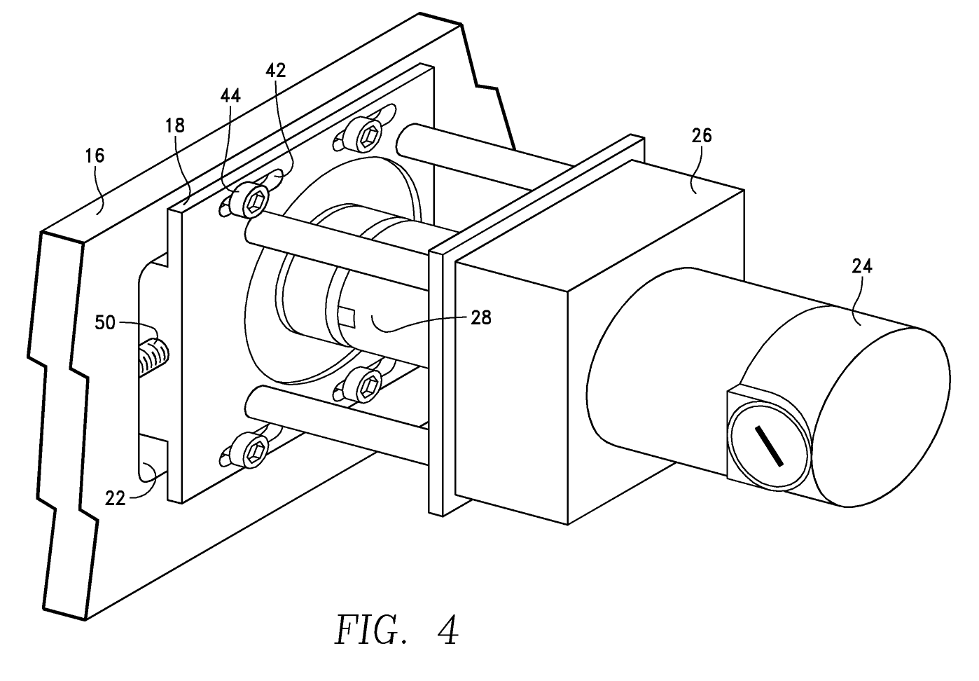

It is advantageous to form chamfers 34 in the corners of the rollers 12, 14 adjacent the shields 30, as illustrated in the cross-sectional view of FIG. 5. The chamfers 34 reduce breakage of the rollers 12, 14 contacting the shields 30 as they counter-rotate about roller axes 12a, 14a.

Because silicon is prone to sensitive to shock and to cracking and fracturing, soft plastic such as Teflon may be interposed between silicon and metal parts.

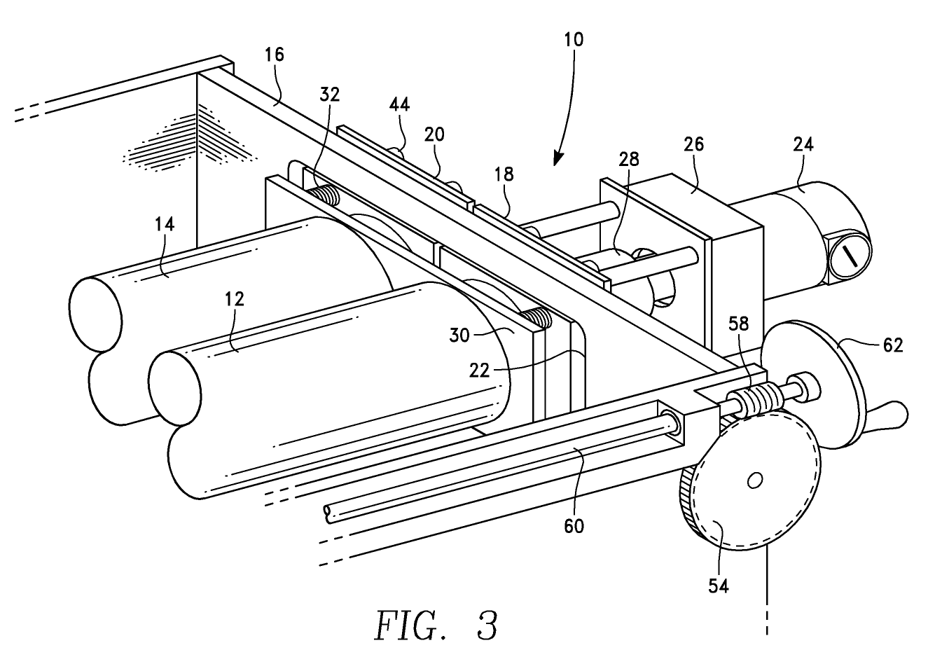

Each of the four carriers 18, 20 supporting the rollers 12, 14 and their motors 24 is horizontally guided along four horizontal slots 42, illustrated in detail in the orthographic view of FIG. 4, in the carriers 18, 20 closely passing the thread bodies of socket head cap screws 44 screwed into the frame 16. In view of the large lateral forces produced by the crushing, the holding power of the cap screws 44 can be increased by roughening one or both engaging surfaces at the interface between the carriers 18, 20 and the frame 16. Other guiding means such as square keys engaged in horizontally extending keyways. The carriers 18, 20 are horizontally movable through adjustment mechanisms. The adjustment mechanisms for the carriers 20 associated with the second roller 14 may be two simple knob 46 and attached threaded rod screwed into the respective carrier 20 and axially retained in the frame 16. Once the desired orientation of the first roller 14 has been accomplished, cap screws 44 on the carriers 20 are tightened to fix the first roller 14 in that orientation. The adjustment mechanism for the carriers 18 associated with the first roller 12 may be more complex. Threaded rods 50, illustrated more clearly in the yet further enlarged orthographic view of FIG. 4, are threaded into the respective carriers 18. Their other ends are axially retained in the frame 16 and connected to wheel gears 52, 54, each engaged through respective worm gears 56, 58 on a rotary shaft 60 having an adjustment handle 62 on its end to simultaneously and equally move both carriers 18 associated with the first roller 12 in the horizontal direction toward or away from the first roller 14 to thereby provide a tandem adjustment mechanism.

In one optional mode of operation, the wheel gears 52, 54 are coupled together and the carriers 18 associated with the first roller 12 are locked in place by their cap screws 44. The two carriers 20 associated with the second roller 14 are unlocked by loosening their cap screws 44, and the two handles 46 adjust the position of the unlocked carriers 20 until the two rollers 12, 14 closely engage along their entire lengths. As a result, the axes of the first and second rollers 12, 14 are parallel and the gap between them is essentially zero. The cap screws 44 on the carriers 20 associated with the second roller 14 are then tightened to lock the second roller 14 into its final position. Thereafter, any rotation of the adjustment handle 62, assuming the cap screws 48 on the carriers 18 of the first roller 12 are loosened, causes the gap between the two rollers 12, 14 to change but to be uniform along the lengths of the rollers 12, 14. In practice, it has been found sufficient to use a feeler gauge between the rollers 12, 14 to establish the gap, for example, at 100 microns and to thereafter lock the carriers 18, 20 and associated rollers 12, 14 in place with or without the use of the tandem adjustment mechanism. It is understood that the cap screws and adjustment handle can be replaced by electro-mechanical means to make the desired adjustments and to fix them in place. The locking of the carriers 18, 20 can be further improved by placing lock nuts on the two threaded rods 50 associated with the carriers 18 of the first roller 12 and on two unillustrated rods associated with the carriers 20 of the second roller 14. All the threaded rods are axially retained in the frame 16 but threaded into the respective carriers 18, 20 to form respective worm drives. Once the desired inter-roller gap is established, the lock nuts are tightened against the associated carriers 18, 20.

Once the gap is selected and fixed, preferably by tightening the cap screws 44 and lock nuts, silicon particles are loaded into the V-shaped region between the tops of the rollers 12, 14, and the counter-rotating rollers 12, 14 crush the particles into finer sized particles, which eventually fall through the gap between the rollers 12, 14 and are collected in an unillustrated pan positioned beneath the gap between the rollers 12, 14.

For purposes of this invention, grinding and milling are equivalent terms unless specified otherwise and crushing with a roller mill is a special case of milling.

The size of the inter-roller gap may be varied but fine powder is produced for differently sized BBs for a variety of gap sizes. Gaps as small as 100 microns have been successfully tested and with improved roller circularity can be reduced further. The powder loading needs to be carefully controlled. If too few particles are loaded, the conversion rate or yield decreases. If too many particles are loaded, the rollers jam. It is thus desirable to constantly feed particles to the rollers, for example, by a conveyor or elevator. However, the particles should be evenly distributed along the length of the rollers.

An embodiment of a feedstock supply system 70, illustrated in the cross-sectional view of FIG. 5, is generally positioned above the two rollers 12, 14 separated by a gap 72 and counter-rotating about their respective centers to force silicon feedstock fed from above downwardly through the narrow gap 72, thereby milling and crushing the feedstock to smaller sized particles. A linear funnel 74 formed of two inclined sidewalls extending into the plane of the illustration parallel to the axes 12a, 14a of the rollers 12, 14 and having closed ends. The linear funnel 74 includes at its bottom a outlet slot 66 extending linearly parallel to the axes of the rollers 12, 14. A shield 78 extends on the sides away from the outlet 76 to confine any powder to the area above the inter-roller gap 72. The funnel outlet slot 76 is preferably positioned vertically above one of the rollers 12, 14 away from the inter-roller gap 72 so that any particles broken in the crushing or even unground BB pellets do not fly upwardly through the funnel outlet slot 66. The funnel 74 and shield 78 are advantageously formed of high-purity silicon such as virgin polysilicon. Thereby, upwardly flying particles striking the funnel 78 or shield 78 do not ablate contaminants from them.

An inclined V-shaped trough 80 is positioned with its open end vertically above the funnel 74 and its closed end 84 supported on a vibrator 86. Unillustrated feeder means continuously or intermittently supply silicon particles to the closed end 84 of the trough 80, which is inclined upwardly toward the open end 82. This portion of the feedstock supply system 70 has been described in aforecited patent publication 2008/0054116, which should be consulted for further detail. As described there, the vibration causes small particles to march up the bottom of the inclined trough 80 and fall from its open end 82 as fed particles 88, which pass through the funnel outlet 76 to be crushed to smaller size by the rotating rollers 12, 14. Crushed particles 90 fall into a collector pan 92 and develop into a mound 94 of ground silicon powder. Preferably the trough 80 and collector 90 are also made of high-purity silicon although other high-purity material such as polypropylene or Teflon may be used for the collector pan 80.

The vibrator 86 is mounted on an axial stage 94 which reciprocates in the axial direction of the two rollers 12, 14 such that silicon feedstock is distributed along nearly the entire lengths of the rollers 12, 14.

Silicon is highly prone to oxidation, especially during the grinding phase when dangling silicon bonds are exposed at the fracture plane. Accordingly, it is advantageous to perform the crushing in an inert ambient, for example, of nitrogen or argon. The oxygen partial pressure should be kept to less than 100 ppm (10⁻⁴) of the ambient pressure, which may be atmospheric or slightly over pressured. Further, the milling produces fine powder which presents an inhalation problem and silicon powder may ignite and burn, that is, oxidize, in the presence of oxygen. Both problems are greatly reduced by crushing within an enclosure filled with inert gas.

Although nitrogen may react with the silicon dangling bonds created during crushing, it is possible that the resultant very thin nitride layer acts as a protective layer against subsequent oxidation of the underlying silicon, which absent the protective layer would develop more deeply into the ground silicon particle.

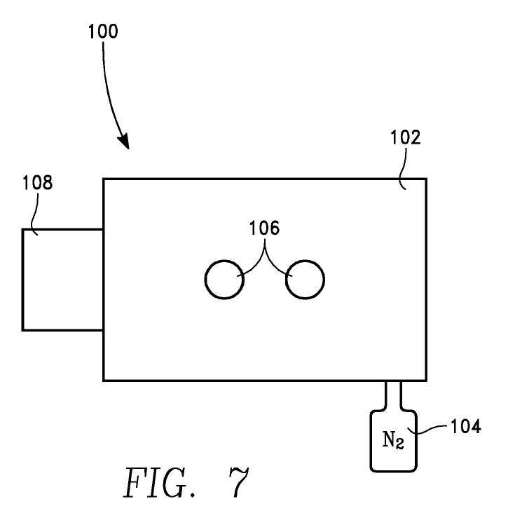

An example of a environmental processing chamber 100, schematically illustrated in FIG. 7 includes a vacuum-pumped or vented glove box 102. A nitrogen source 104 supplies nitrogen to the glove box 102 to achieve the desired low concentration of oxygen. The glove box 102 includes two glove holes 104 with gloves sealing the interior from the exterior but allowing an operator to manually manipulate equipment and products within the nitrogen-filled glove box 102.

The crushing system 10 and the feed system 70 are located inside the glove box 102. The glove box 102 also includes a load lock 108 having an exterior vacuum door to ambient, an interior vacuum door to the interior of the glove box 102 and an interior of sufficient size for accommodating feedstock and ground product. In operation, feedstock is placed from the exterior into the load lock 108 and its exterior door is closed. After the load lock 108 has been backfilled with nitrogen to the requisite low oxygen level, the interior door is opened and the operator working through the glove holes 106 can transfer feedstock to the feed system. At the end of grinding a load of feedstock, the operator may transfer the contents of the collector pan into a sealable bottle, which is then transferred out of the glove box 102 through the load lock 108 and a new load of feedstock may be loaded into the glove box 102.

The described processing system is effective at producing significant amounts of milled silicon particles since the crushing is substantially a continuous process. However, it is understood that industrial production would be in large part automated and material would preferably be nearly continuously loaded and unloaded from the inert processing ambient.

The crushed silicon may be sieved to obtain the appropriate size for jet milling without damage to its silicon walls, for example, in the range of about 30 to 80 microns although somewhat smaller particles are desired. Sieving also removes elongate particles having minor dimensions less than the inter-roller gap 72 but a major dimension is larger than the inter-roller gap 72. Sieving has been performed with sieves of different screen mesh sizes having uniform hole sizes in the range of 30 to 90 microns. The size of the mesh screen determines the maximum size of the particles passing the screen. A lower limit of the particle size can be achieved by a separate sieving step with a smaller mesh size and retaining the particles not passed through the sieve. Of course, sieving selects particles according to their minimum dimensions and irregularly shaped particles having larger maximum dimensions than the screen mesh may nonetheless pass the mesh. The screen material should be non-metallic, for example, nylon. The sieving has demonstrated that the roller mill may produce particles considerably smaller than the inter-roller gap 72.

One mode of grinding produces both fine powder and larger particles, which may been partially crushed but not reduced to powder. After sieving, the larger particles may be milled multiple times to increase the yield of fine powder.

Progressive grinding can be accomplished in at least two ways. In a first approach, relatively large particles are ground with a relatively large inter-roller gap. The ground particles are collected, the inter-roller gap is reduced, and the particles are ground a second time. This process can be repeated more times. In a second approach, multiple roller mills 10 are stacked above each other with their respective rollers 12, 14 approximately above each other and more importantly their inter-roller gaps are approximately above each other so that the powder ground in the uppermost roller mill is immediately ground again in the next lower roller mill. The inter-roller gaps are selected to be largest for the highest mill and to progressively decrease for the lower mills. It is even possible to use the same inter-roller gap among the stacked crushers to increase the yield.

The silicon powder produced by the roller mill may be used as feedstock for the silicon-lined jet mill or it may be used directly as the feedstock for the silicon-lined plasma gun. The jet mill allows powder size to be controllably reduced to a size of between 1 to 5 microns.

If the crushed silicon powder is to be further ground in a jet mill, the jet mill may additionally be placed within the glove box 102 and the crushed particles transferred to the jet mill without being removed from the glove box 102.

The various aspects of the invention provide an economical and dependable process for producing silicon particles and powders of high purity and controlled small size. If desired, the silicon powder is doped to a controlled level by a simple and economical process. The invention provides economic feedstock for plasma spraying of semiconductor grade silicon.

1. A method of doping silicon powder, comprising:
exposing silicon particles to a liquid dopant capable of doping silicon to a given semiconductivity type to create doped silicon particles; and
pulverizing the doped silicon particles to lesser size to create a first batch of silicon powder.

2. The method of claim 1, further comprising plasma spraying silicon using a silicon powder feed comprising the first batch.

3. The method of claim 2, further comprising:
pulverizing lesser-doped silicon particles of lesser doping than the doped silicon particles to create a second batch of silicon;
mixing predetermined amounts of the first and second batches of silicon of which the silicon powder feed is comprised.

4. The method of claim 1, wherein the liquid dopant comprises boric acid.

5. The method of claim 1, wherein the liquid dopant comprises phosphorus oxychloride.

6. The method of claim 1, wherein the exposing step comprises spraying a predetermined amount the liquid dopant on the silicon particles.

7. The method of claim 1, wherein the pulverizing comprises roller milling the silicon particles between two counter-rotating rollers having cylindrical surface portions consisting essentially of elemental silicon.

8. A roller mill adapted for milling silicon, comprising:
a pair of juxtaposed rotatable rollers having surface portions juxtaposing each other comprising elemental silicon, a gap being formable between the rollers.

9. The mill of claim 8, wherein the gap has a controlled variable size.

10. The mill of claim 8, further comprising end plates having surface portion comprising elemental silicon biased against axial ends of the rollers.

11. The mill of claim 10, wherein corners of the rollers adjacent the end plates are chamfered.

12. A roller mill system, comprising plural vertically stacked pairs of the rollers of claim 8.

13. The mill of claim 8, further comprising a feed system reciprocating parallel to the axes of and above the rollers for feeding feedstock to the rollers.

14. The mill of claim 13, wherein the feed system includes a linear funnel with a linear outlet.

15. The mill of claim 14, wherein the linear outlet is positioned above one of the rollers and laterally away from a gap between the rollers.

16. The mill of claim 13, wherein the linear funnel is composed of elemental silicon.

17. A method of pulverizing silicon, comprising:
milling silicon in the roller mill of claim 8; and
sieving the product of the milling step to a predetermined size range.

18. The method of claim 17, wherein the size range is 20 to 80 microns.

19. The method of claim 17, wherein the predetermined size range extends entirely over sizes less than the gap between the rollers.

20. The method of claim 17, further includes jet milling the sieved product.
